(19) United States
(12) Patent Application Publication
(10) Pub. No.: US 2011/0114803 A1
(43) Pub. Date: May 19, 2011

(54) CIRCUIT SUPPORT APPARATUS FOR MEDICAL USE AND PIVOT MECHANISM THEREOF

(75) Inventors: Gary C. J. LEE, I-Lan (TW); Shu-Ping ZOU, Taipei (TW); Hsuan-Liang KANG, Taipei (TW)

(73) Assignee: Galemed Corporation

(21) Appl. No.: 12/947,053

(22) Filed: Nov. 16, 2010

(30) Foreign Application Priority Data
Nov. 17, 2009 (TW) 098221370

(51) Int. Cl. F16L 3/08

(52) U.S. Cl. 248/70

(57) ABSTRACT

The circuit support apparatus of the invention includes a pivot mechanism, two arms and a circuit holder connected to one of the arms. The pivot mechanism includes a stationary ring, a rotary ring correspondingly connecting with the stationary ring and being capable of rotating with respect to the stationary ring, a ratchet gear, a push button connecting with the ratchet gear. The rotary ring has a plurality of first teeth. The ratchet gear has a second tooth only being rotated with respect to the first teeth in one direction. The arms are respectively connected to the stationary ring and the rotary ring. When the push button is pushed, the second tooth is shifted out of mesh with the first teeth, and the rotary ring with one arm is rotatable with respect to the stationary ring with the other arm. It is quite safe and convenient for users.

### BACKGROUND OF THE INVENTION

1. Field of the Invention

The present invention relates to a support apparatus, particularly relates to a circuit support apparatus for medical use and a pivot mechanism thereof.

2. Description of Related Art

In medical procedures, a breathing circuit is often adopted to assist a patient in breathing. The circuit provides an airway for passing air or oxygen from a ventilator into the lungs of the patient. However, in order to avoid obstruction of air or oxygen flow caused by the kinking or pressing the circuit, a circuit support apparatus is often used to hold up the circuit at a altitude.

Conventional circuit support apparatus has an upper arm and a lower arm pivotally connected with each other by a pivot screw, and a circuit holder connected to the end of the upper arm. The pivot screw can be loosened to adjust the relative position of the two arms, and then be tightened to secure the arm position. However, the pivot screw cannot be easily tightened, which causes inconvenience for practical use, or the pivot screw becomes loose and can no longer hold the weight or the hanger arm in the desired position or angle, and consequently, the upper arm may drop and injure practitioner or patient. The weight of the upper arm further increases risk and pain to the patient or the practitioner adjusting the pivot screw when the upper arm is unintentionally dropped. This is particularly important as to avoid severe injury caused by heavy upper arm dropping on children's head.

### SUMMARY OF THE INVENTION

The present invention is to provide a pivot mechanism, which is a result of dedicated research and is specifically designed to overcome the above-mentioned inconveniences.

The pivot mechanism of the present invention includes a stationary ring, a rotary ring, a stopping member, a ratchet gear, a push button and an elastic member. The stationary ring has a positioning hole. The rotary ring correspondingly connects with the stationary ring and is capable of rotating with respect to the stationary ring. The rotary ring has an inner peripheral surface and a plurality of first teeth formed circularly on the inner peripheral surface. The stopping member is inserted in the positioning hole. The ratchet gear is arranged inside the rotary ring and connects with the stopping member. The ratchet gear has a second tooth meshing with the first teeth of the rotary ring and only is rotated with respect to the first teeth in one direction. The push button has a center post extending. The center post passes through the rotary ring and connects with the ratchet gear. The elastic member is arranged around the center post and is pressed between the push button and the rotary ring. When the push button is pushed toward the ratchet gear, the second tooth of the ratchet gear is shifted out of mesh with the first teeth, and the rotary ring is capable of being rotated with respect to the stationary ring.

The present invention is to provide a circuit support apparatus, which is a result of dedicated research and is specifically designed to overcome the above-mentioned inconveniences.

The circuit support apparatus of the present invention includes a pivot mechanism, two arms and a circuit holder. The pivot mechanism includes a stationary ring, a rotary ring, a stopping member, a ratchet gear, a push button and an elastic member, the stationary ring having a positioning hole, the rotary ring correspondingly connecting with the stationary ring and being capable of rotating with respect to the stationary ring, the rotary ring having an inner peripheral surface and a plurality of first teeth formed circularly on the inner peripheral surface, the stopping member inserted in the positioning hole, the ratchet gear arranged inside the rotary ring and connected with the stopping member, the ratchet gear having a second tooth meshing with the first teeth of the rotary ring and only being rotated with respect to the first teeth in one direction, the push button having a center post extending, the post passing through the rotary ring and connecting with the ratchet gear; and the elastic member arranged around the center post and pressed between the push button and the rotary ring. The arms are respectively connected to the stationary ring and the rotary ring. The circuit holder is connected to one of the arms. When the push button is pushed toward the ratchet gear, the second tooth of the ratchet gear is shifted out of mesh with the first teeth, and the rotary ring with one arm is capable of being rotated with respect to the stationary ring with the other arm.

By pressing and holding on to the push button, the arm can be adjusted quickly to raise or lower the height of the circuit holder. By releasing the push button, the positions of the arm can then be fixed. It secures the patient and practitioner's safety and improves the convenience of operation. In case of emergency where the circuit holder needs to be raised up immediately, the user can simply lift the circuit holder without pressing the push button. However, the circuit holder may not be lowered without pressing on the push button, which is a safety precaution incorporated into this device.

### BRIEF DESCRIPTION OF THE DRAWINGS

FIG. 1 is a perspective view of the circuit support apparatus of the present invention;

FIG. 2 is an exploded view of the circuit support apparatus of the present invention;

FIG. 3 is another perspective view from a different angle of the circuit support apparatus of the present invention;

FIG. 4 is a cross-sectional view of the pivot mechanism of the present invention;

FIG. 5 is a perspective view of the clamp mechanism of the present invention;

FIG. 6 is a schematic view illustrating the rotation of the rotary ring;

FIG. 7 is a schematic view illustrating the ratchet gear shifting out mesh with the rotary ring;

FIG. 8 is a schematic view illustrating the rotation of the rotary ring;

FIG. 9 is a perspective view illustrating the position changing of the circuit support apparatus

FIG. 10 is a perspective view illustrating the pivot mechanisms and the flexible arm; and

FIG. 11 is a perspective view illustrating the joint mechanism.

### DETAILED DESCRIPTION OF THE INVENTION

The present invention is described below in detailed with the reference to accompanying drawings. It should be mentioned that the drawings are provided for illustration only and the invention is not limited to the drawings.

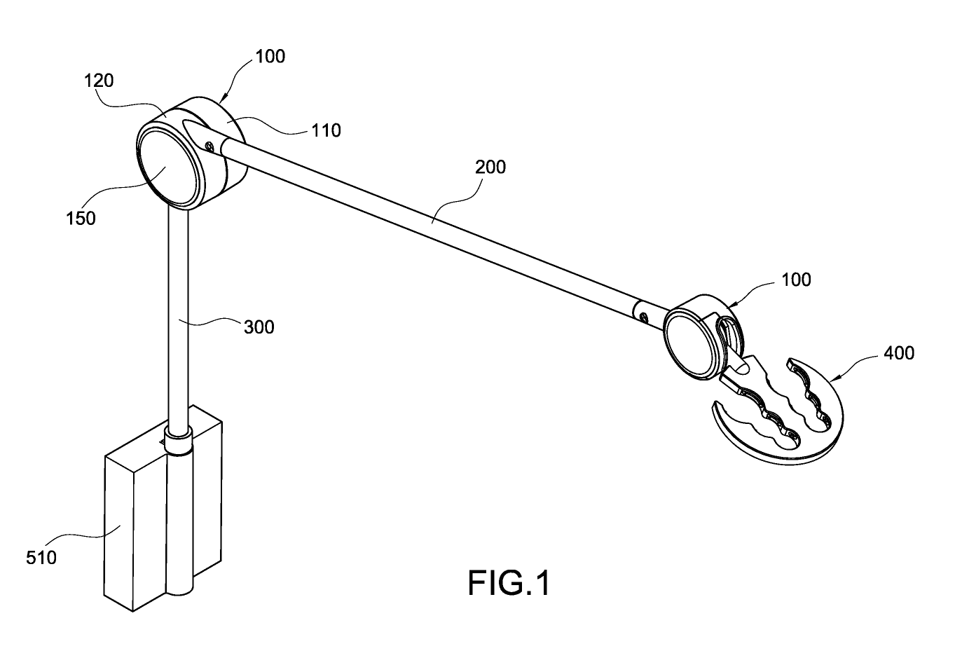

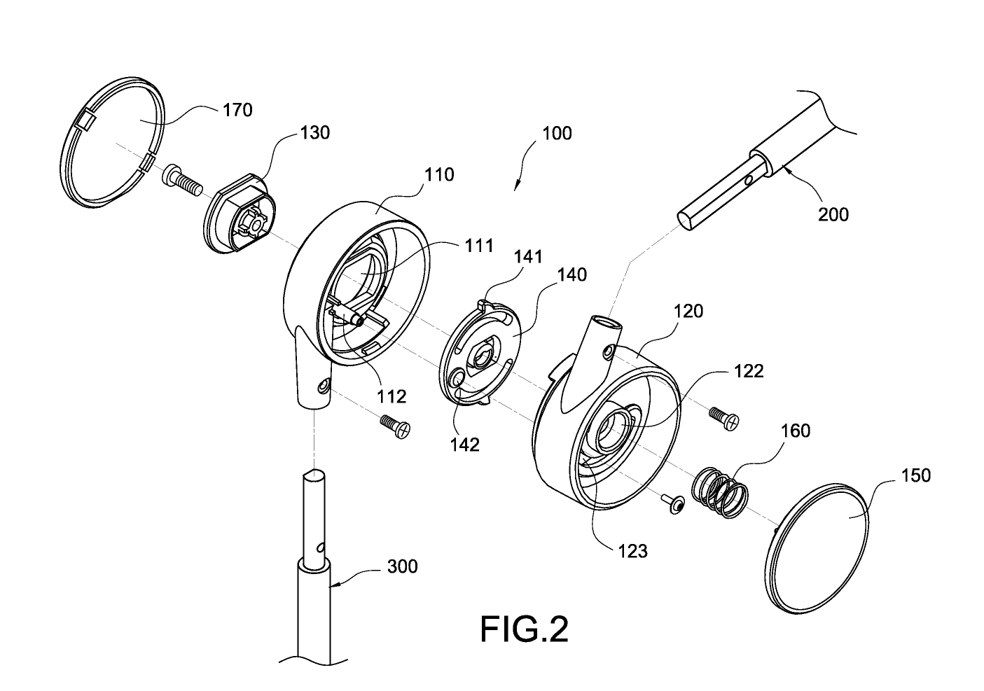

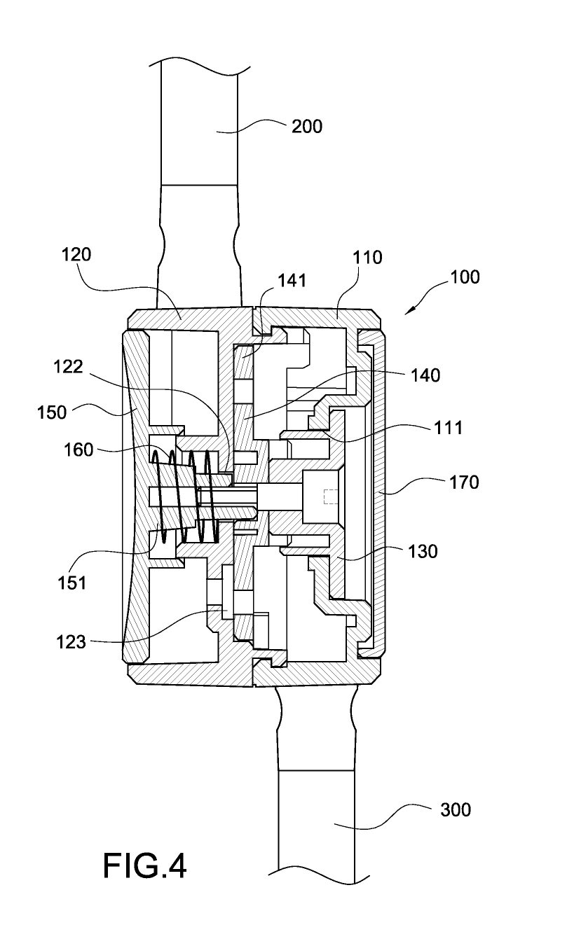

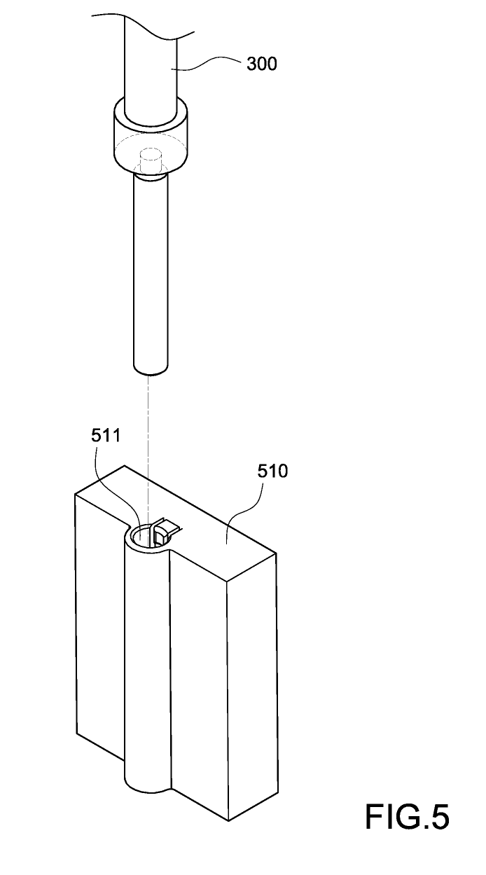

Referring to FIG. 1 to FIG. 5, a circuit support apparatus according to an embodiment of the present invention includes a pivot mechanism 100, two arms 200, 300, a circuit holder 400 and a channel holder 510.

The pivot mechanism 100 includes a stationary ring 110, a rotary ring 120, a stopping member 130, a ratchet gear 140, a push button 150, an elastic member 160 and a cover 170.

The stationary ring 110 has a positioning hole 111 near its center portion. The positioning hole 110 is about rectangular shape. In addition, the stationary ring 110 also has a fixing post 112 near the positioning hole 111, where the fixing post 112 extends along a center axial direction of the stationary ring 110.

The rotary ring 120 is shaped to coincide with the shape of the stationary ring 110 and correspondingly connected with the stationary ring 110. Thus, the rotary ring 120 is capable of rotating with respect to the stationary ring 110. The rotary ring 120 has an inner peripheral surface and a plurality of first teeth 121 formed circularly on the inner peripheral surface. The rotary ring 120 has a through hole 122 formed near its center. And an semi-arc-shaped sliding groove 123 for passing through the fixing post 112 is also formed between the through hole 122 and the first teeth 121. And the fixing post 112 can freely slide in the sliding groove 123.

The stopping member 130 is inserted in the positioning hole 111 and the shape of the stopping member 130 is to coincide with the shape of the positioning hole 111. Thus, the stopping member 130 is not able to rotate in the positioning hole 111, but is able to move along the center axis of the stationary ring 110.

The ratchet gear 140 is arranged inside the rotary ring 120 and connects with the stopping member 130. The ratchet gear 140 has two second teeth 141 formed on the outer edge thereof for meshing with the first teeth 121 of the rotary ring 120. The ratchet gear 140 has a fixing hole 142 for passing through the fixing post 112. Besides, two arc-shaped grooves (not labeled) formed adjacent to the second teeth 141 allow the second teeth 141 can be forced to squeeze inwardly. Thus, the rotary ring 120 is able to rotate with respect to the ratchet gear 140. But, the asymmetric shape of the second teeth 141 makes the second teeth 141 only be rotated with respect to the first teeth 121 in one direction.

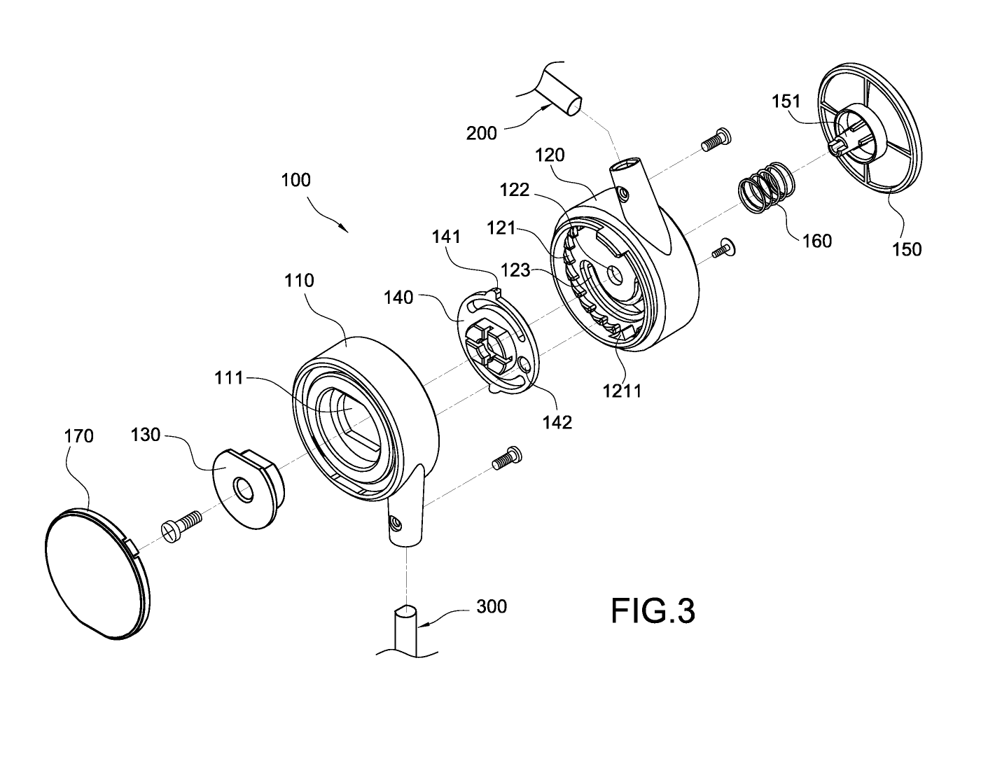

In addition, as can be seen in the FIG. 3, one of the first teeth 121 has a thicker thickness than that of the other first teeth 121 and is defined as a limiting tooth 1211. The limiting tooth 1211 can be used to limit the rotating range of the second teeth 141. Alternatively, such a limit means can be replaced by other types limit means.

The push button 150 is arranged on a side of the rotary ring 120 and has an outer edge contacting with the inner peripheral surface of the rotary ring 120. The push button 150 has a center post 151 extending there from for passing through the rotary ring 120 and connecting with the ratchet gear 140. Thus, the rotary ring 120 can not rotate with respect to the ratchet gear 140. The ratchet gear 140 can only move along the center axis of the rotary ring 120.

The connection means to connect the stopping member 130, the ratchet gear 140 and the push button 150 can be screw connection, weld connection, or stick connection, and not limited thereto.

The elastic member 160 is arranged around the center post 151 and pressed between the push button 150 and the rotary ring 120. The elastic member 160 can be, but not limited to, a spring or a rubber.

The cover 170 correspondingly seals one end of the stationary ring 110. The cover 170 and the push button 150 cooperatively seal the stopping member 130, the ratchet gear 140, and the elastic member 160 in the stationary ring 110 and the rotary ring 120 to avoid contamination from outside.

The two arms 200, 300 are respectively connected to the stationary ring 120 and the rotary ring 110. More specifically, one end of the arm 200 is connected to the outer peripheral surface of the rotary ring 120. The connection means to connect the arm 200 to the rotary ring 120 can be, but not limited to, screw connection, weld connection, or stick connection.

One end of the arm 300 is connected to the outer peripheral surface of the stationary ring 110. The connection means to connect the arm 300 to the stationary ring 110 can be screw connection, weld connection, or stick connection, and not limited thereto. The extending direction of the arm 300 is perpendicular to the center axis of the stationary ring 110. The arm 200 is able to rotate with respect to the arm 300 by the pivot mechanism 100.

The circuit holder 400 is connected to another end of the arm 200. In addition, another pivot mechanism 100 can be further arranged between the circuit holder 400 and the arm 200, which can increase the swivel angle of the circuit holder 400.

The channel holder 510 is used for connecting one of the arms. In this embodiment, the channel holder 510 has an inserting hole 511 for inserting the arm 300.

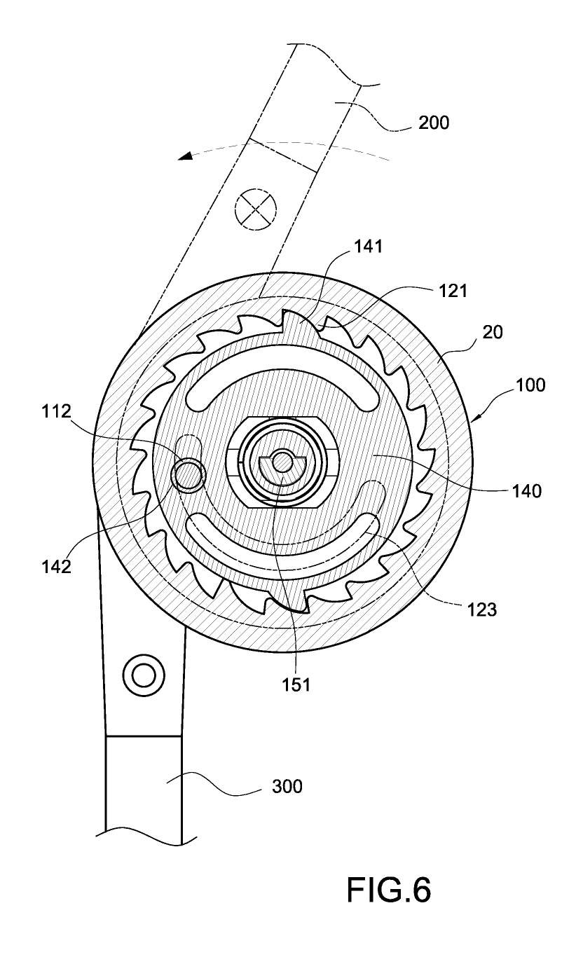

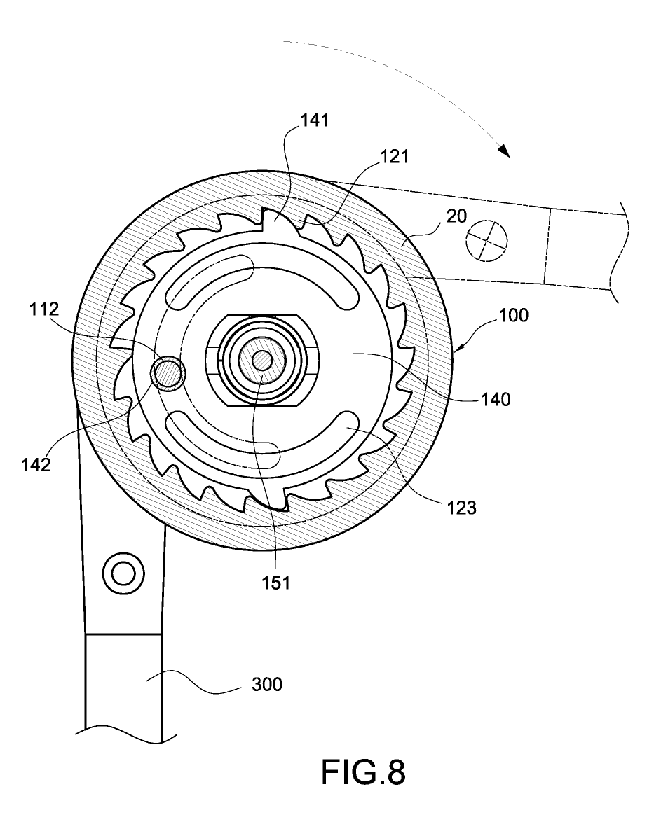

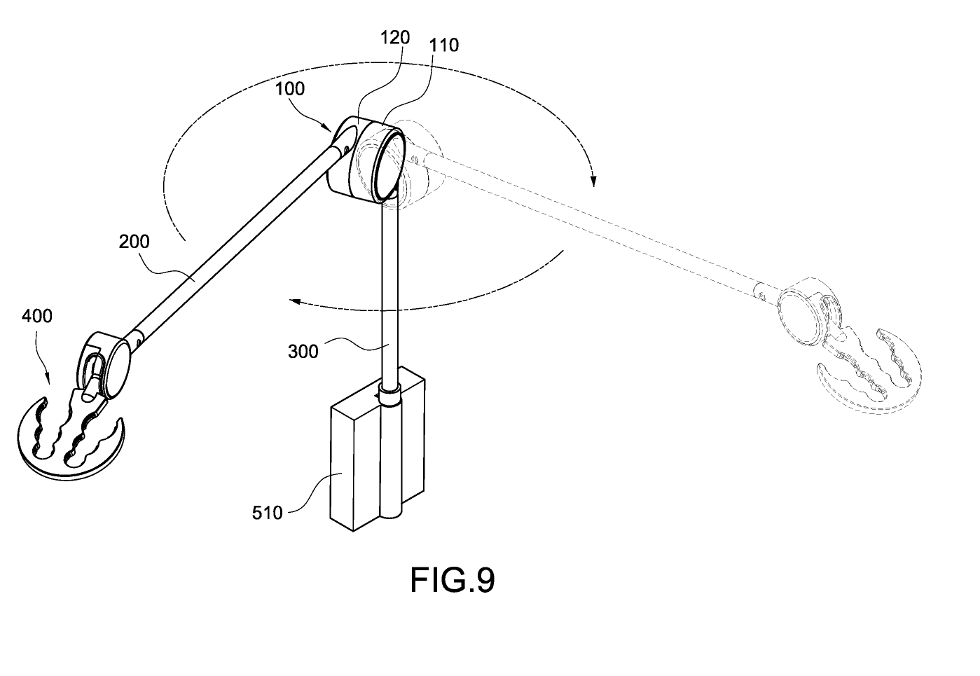

As shown in FIG. 6 to FIG. 9, in practical use, the elastic member 160 is elastically pressed between the push button 150 and the rotary ring 120. The elastic member 160 forces the push button 150 away from the rotary ring 120, so the second teeth 141 of the ratchet gear 140 are consequently meshed with the first teeth 121. Then, the rotary ring 120 can be rotated with respect to the stationary ring 110 only in counterclockwise direction. In other words, the arm 200 can only be swung with respect to the arm 300 only in counterclockwise direction, and the circuit holder 400 can only be lifted up. Since of the fixing post 112 can only be moved in the span of the sliding groove 123, the available swing range of the arm 200 is limited. The arm 200 can not be swung beyond its perpendicular position and can not be swung in clockwise direction either. So, once the circuit holder 400 is lifted up, it can not be lowered down. In case of emergency where the circuit holder 400 needs to be raised up immediately, the user can simply lift the circuit holder 400 without pressing the push button 150. In another aspect, the circuit holder 400 may not be lowered without pressing on the push button 150, which is a safety precaution incorporated into this apparatus.

To adjust the position of the arm 200 and the altitude height of the circuit holder 400, the push button 150 can be pushed against the elastic force of the elastic member 160 to move the ratchet gear 140 and the stopping member 130. The ratchet gear 140 is moved along the center axis of the rotary ring 120, which causes the second teeth 141 shift out of mesh with the first teeth 121. Then, the rotary ring 120 can freely be rotated with respect to the stationary ring 110 in clockwise direction. In other words, the arm 200 can be swung with respect to the arm 300 in clockwise direction, and the circuit holder 400 can be lowered down. After the adjusting is finished, the push button 150 can be released to re-mesh the second teeth 141 with the first teeth and to fix the position of the arm 200 and the circuit holder 400. Since the available swing range of the arm 200 is limited by the fixing post 112 with the sliding groove 123, the arm 200 can not be swung to overlap with the arm 300, which prevents users from being injured by the arms 200, 300.

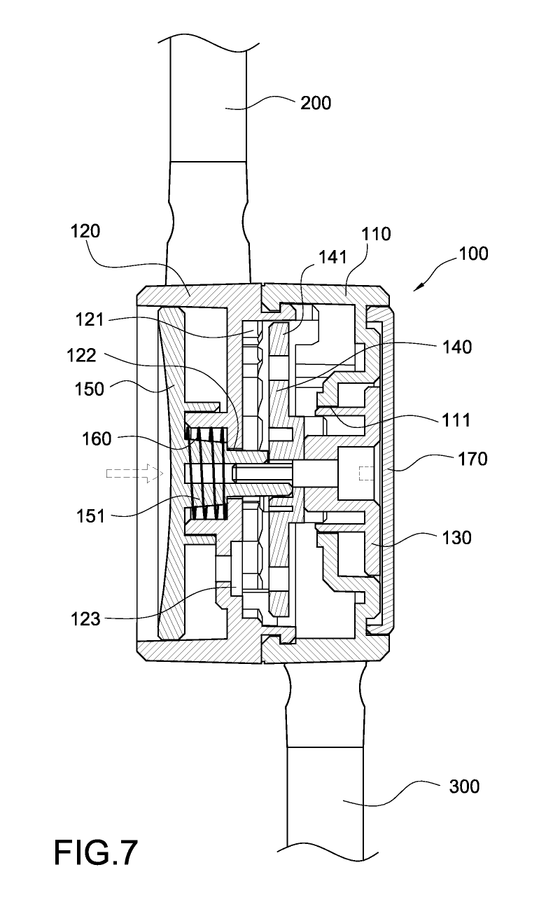

Simply speaking, pushing the push button 150, the arm 200 can be adjusted quickly to freely raise or lower the altitude height of the circuit holder 400. Releasing the pushing button 150, the positions of the arm 200 and the circuit holder 400 can then be fixed. Such an operation is very convenient for users. While the push button 150 is pushed, the ratchet gear 140 is moved out of mesh with the first teeth 121 by the pushing button 150. Since the limiting tooth 1211 has a thicker thickness and the movement of the ratchet gear 140 is confined by the stopping member 130 (see FIG. 7), the ratchet gear 140 can rotate within a limited range after moving out of mesh with the first teeth 121, due to that the second teeth 141 can be stopped by the limiting tooth 1211.

The arm 300 can be inserted into the inserting hole 511. When the arm 300 is rotated in inserting hole 511, the horizontal position of the circuit holder 400 can be changed with respect to the channel holder 510 according to the actual situation.

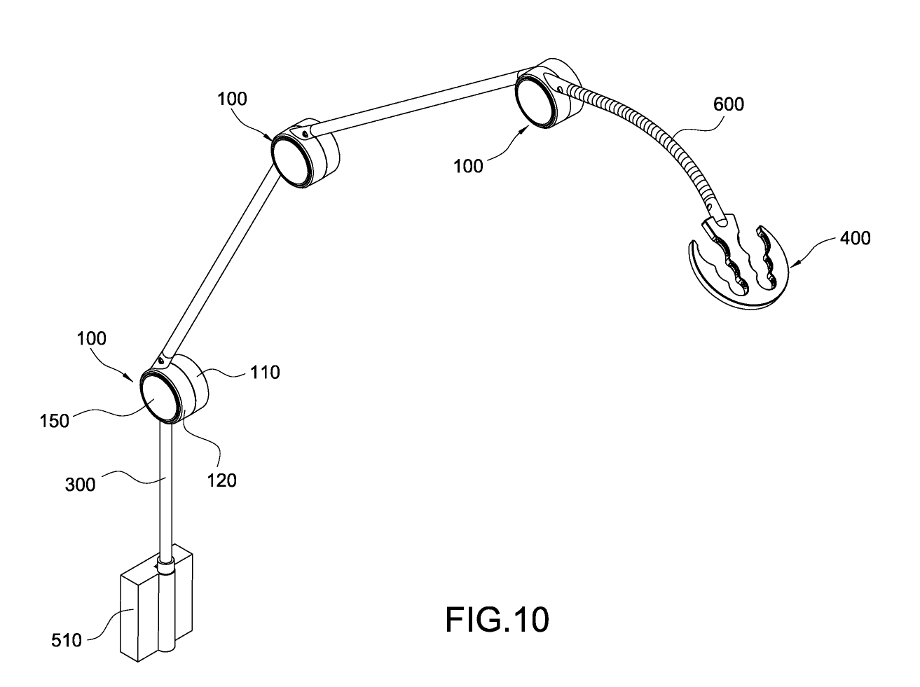

As illustrated in FIG. 10, more than two arms with more than one pivot mechanism 100 can be provided to form a circuit support apparatus, which provides the circuit holder 400 to move to various desired locations. Besides, the extremity arm 600 can be a flexible arm to allow the circuit holder 400 to adjust its position even more freely.

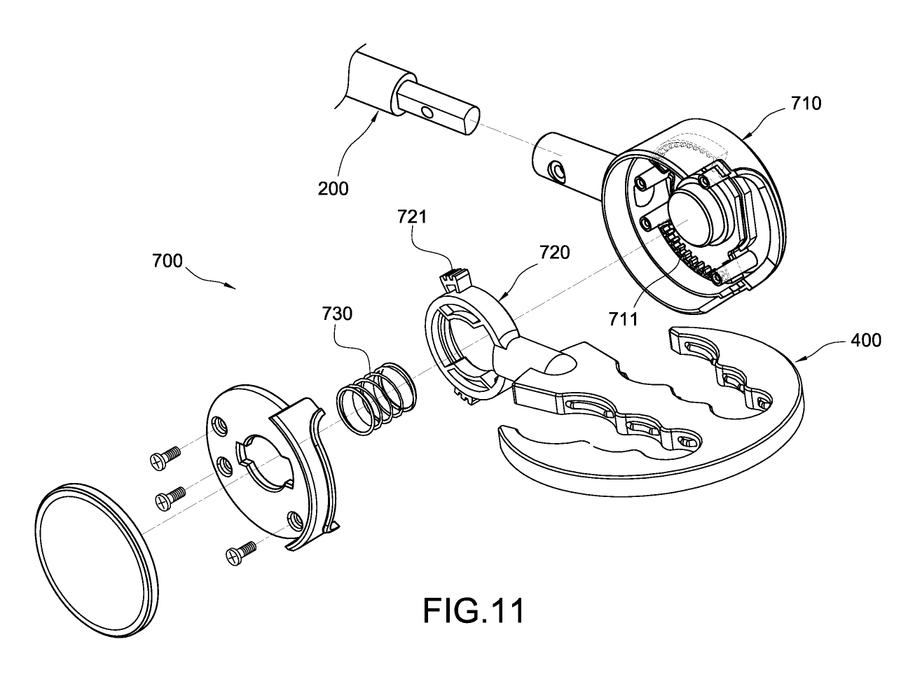

Referring to FIG. 11, the circuit support apparatus may includes a joint mechanism 700 connected between the arm 200 and the circuit holder 400. The joint mechanism 700 includes a positioning ring 710, an embedded ring 720 and a spring 730 pressed between the positioning ring and the embedded ring. The positioning ring 710 has a plurality of teeth 711 formed circularly therein. The embedded ring 720 has a plurality of teeth 721 formed circularly and meshing with the teeth 711 of the positioning ring 710. The arm 200 is connected to the outer peripheral surface of the positioning ring 710 and the circuit holder 400 is connected to the outer peripheral surface of the embedded ring 720.

When the embedded ring 720 is pushed, the teeth 711 of the positioning ring 710 are shifted out of mesh with the teeth 721 of the embedded ring 720 and the positioning ring 710 can be rotated with respect to the embedded ring 720 in both counterclockwise and clockwise directions. When the embedded ring 720 is released, the teeth 711 are going to re-mesh with the teeth 721 and the position of the circuit holder 400 is fixed.

Although the present invention has been described with reference to the foregoing preferred embodiments, it will be understood that the invention is not limited to the detail thereof. Various equivalent variations and modifications can still occur to those skilled in this art in view of the teachings of the present inventions. Thus, all such variations and equivalent modifications are also embraced within the scope of the invention as define in the appended claims.

What is claimed is:

1. A pivot mechanism comprising:
a stationary ring having a positioning hole;
a rotary ring correspondingly connecting with the stationary ring and being capable of rotating with respect to the stationary ring, the rotary ring having an inner peripheral surface and a plurality of first teeth formed circularly on the inner peripheral surface;
a stopping member inserted in the positioning hole;
a ratchet gear arranged inside the rotary ring and connecting with the stopping member, the ratchet gear having a second tooth meshing with the first teeth of the rotary ring and only being rotated with respect to the first teeth in one direction;
a push button having a center post extending therefrom, the center post passing through the rotary ring and connecting with the ratchet gear; and
an elastic member arranged around the center post and pressed between the push button and the rotary ring,
wherein when the push button is pushed toward the ratchet gear, the second tooth of the ratchet gear is shifted out of mesh with the first teeth, and the rotary ring is rotatable with respect to the stationary ring.

2. The pivot mechanism as claim 1, wherein the stationary has a fixing post and the ratchet gear has a fixing hole passing through the fixing post and the rotary ring has an arc-shaped sliding groove passing through the fixing post.

3. The pivot mechanism as claim 1, wherein the rotary ring has a through hole for passing through the center post.

4. The pivot mechanism as claim 1, further comprising a cover correspondingly sealing the stationary ring.

5. The pivot mechanism as claim 1, wherein one of the first teeth has a thicker thickness than that of the other first teeth and is defined as a limiting tooth to limit the rotating range of the second teeth.

6. A circuit support apparatus comprising:
a pivot mechanism comprising a stationary ring, a rotary ring, a stopping member, a ratchet gear, a push button and an elastic member, the stationary ring having a positioning hole, the rotary ring correspondingly connecting with the stationary ring and being capable of rotating with respect to the stationary ring, the rotary ring having an inner peripheral surface and a plurality of first teeth formed circularly on the inner peripheral surface, the stopping member inserted in the positioning hole, the ratchet gear arranged inside the rotary ring and connected with the stopping member, the ratchet gear having a second tooth meshing with the first teeth of the rotary ring and only being rotated with respect to the first teeth in one direction, the push button having a center post extending therefrom, the post passing through the rotary ring and connecting with the ratchet gear; and the elastic member arranged around the center post and pressed between the push button and the rotary ring;
two arms respectively connected to the stationary ring and the rotary ring; and
a circuit holder connected to one of the arms, wherein when the push button is pushed toward the ratchet gear, the second tooth of the ratchet gear is shifted out of mesh with the first teeth, and the rotary ring with one arm is rotatable with respect to the stationary ring with the other arm.

7. The circuit support apparatus as claim 6, wherein the stationary has a fixing post and the ratchet gear has a fixing hole passing through the fixing post and the rotary ring has an arc-shaped sliding groove passing through the fixing post.

8. The circuit support apparatus as claim 6, wherein the rotary ring has a through hole for passing through the center post.

9. The circuit support apparatus as claim 6, wherein the pivot mechanism further comprises a cover correspondingly sealing the stationary ring.

10. The circuit support apparatus as claim 6, wherein one of the arms is a flexible arm.

11. The circuit support apparatus as claim 6, further comprising a joint mechanism, the joint mechanism comprising a positioning ring, an embedded ring and a spring pressed between the positioning ring and the embedded ring, wherein the positioning ring has a plurality of teeth formed circularly therein and the embedded ring has a plurality of teeth formed circularly and meshing with the teeth of the positioning ring and one of the arm is connected to the positioning ring and the circuit holder is connected to the embedded ring.

12. The pivot mechanism as claim 6, wherein one of the first teeth has a thicker thickness than that of the other first teeth and is defined as a limiting tooth to limit the rotating range of the second teeth.

13. A pivot mechanism comprising:
a rotary ring having an inner peripheral surface and a plurality of first teeth formed circularly on the inner peripheral surface;
a stopping member;
a ratchet gear arranged inside the rotary ring and connecting with the stopping member, the ratchet gear having a second tooth meshing with the first teeth of the rotary ring and only being rotated with respect to the first teeth in one direction;
a push button having a center post extending therefrom, the center post passing through the rotary ring and connecting with the ratchet gear; and
an elastic member arranged around the center post and pressed between the push button and the rotary ring,
wherein when the push button is pushed toward the ratchet gear, the second tooth of the ratchet gear is shifted out of mesh with the first teeth, and the rotary ring is rotatable with respect to the stopping member.

14. The pivot mechanism as claim 13, wherein the rotary ring has a through hole for passing through the center post.

15. The pivot mechanism as claim 13, wherein one of the first teeth has a thicker thickness than that of the other first teeth and is defined as a limiting tooth to limit the rotating range of the second teeth.
